(19) United States
(12) Patent Application Publication
(10) Pub. No.: US 2009/0269551 A1
(43) Pub. Date: Oct. 29, 2009

(54) RESILIENT FLOOR COVERING WITH HIGH DENT RESISTANCE AND HIGH SOUNDPROOFING PERFORMANCE AND METHOD FOR MANUFACTURING SAME

(75) Inventors: Charles Ferlay, Pontcharras (FR); Herve Julien, Feurs (FR)

Correspondence Address: HESLIN ROTHENBERG FARLEY & MESITI PC, 5 COLUMBIA CIRCLE, ALBANY, NY, 12203, US

(73) Assignee: GERFLOR, Villeurbanne (FR)

(21) Appl. No.: 12/513,059

(22) PCT Filed: Sep. 28, 2007
(86) PCT No.: PCT/FR2007/052045

§ 371 Date: Jun. 25, 2009

(30) Foreign Application Priority Data
Oct. 31, 2006 (FR) 0654644

(51) Int. Cl. B32B 3/12

(52) U.S. Cl. 428/158

(57) ABSTRACT

A floor covering has a sub-layer that includes a flexible covering surface on which is provided a plurality of rigid or flexible projections. The projections are associated with a low-density foam, and foam surrounding the projections is higher than the projections while exposing the upper portion thereof.

The invention relates to the technical sector of resilient floor coverings as used in the construction industry. Said flooring is more particularly used in the clinical environment where hygiene, durability and comfort constraints are paramount. Comfort is taken in particular to mean acoustic comfort, while the requirements on durability are related to the conditions under which people pass to and fro in premises so equipped but so too does the equipment used in such places and which may be rolled around by operators. An example of such equipment would be beds. Current standards impose constraints on the one hand in terms of dent resistance and therefore the capacity of the flooring to resume its original shape after being subjected to heavy crushing (standard NF EN 433) and on the other hand in terms of the acoustic comfort provided by the flooring, measured by the standard (NF EN ISO 140.8). Thus, the specifications at the present time are as follows:

Return is less than 0.2 mm after 2 hours 30 minutes subsequent to being crushed for 2 hours 30 minutes at 50 kg per cm².

Noise reduction is more than 13 dbΔLW (EN ISO 717.2)

In the clinical environment, the level of resistance to the rolling of hospital beds on resilient floor coverings has to be taken into consideration. The applicant has also developed an APAVE-approved assessment method for measuring the force required to move a rolling object over the flooring. This method has allowed the development of foam-backed floors that offer a compromise between crushing and acoustics that meets the regulations.

During this research it was also identified that the actual crush stress sustained by the flooring is of two different orders and can be summarized in two assessment methods:
crushing at 10 kg per cm² for an hour (crushing by a standard chair with a person weighing 100 kg sitting on it)
crushing at 20 kg per m² for 5 hours (crushing by a hospital bed).

These tests can be used to differentiate between floor coverings and reflect the phenomena observed in operation.

The floor coverings proposed by the applicant at the present time fulfill the conditions in terms of crushing and acoustic comfort. However, in heavily used hospital corridors, the personnel complains about soundproof floor coverings, on account of their poor heavy-load rolling capability.

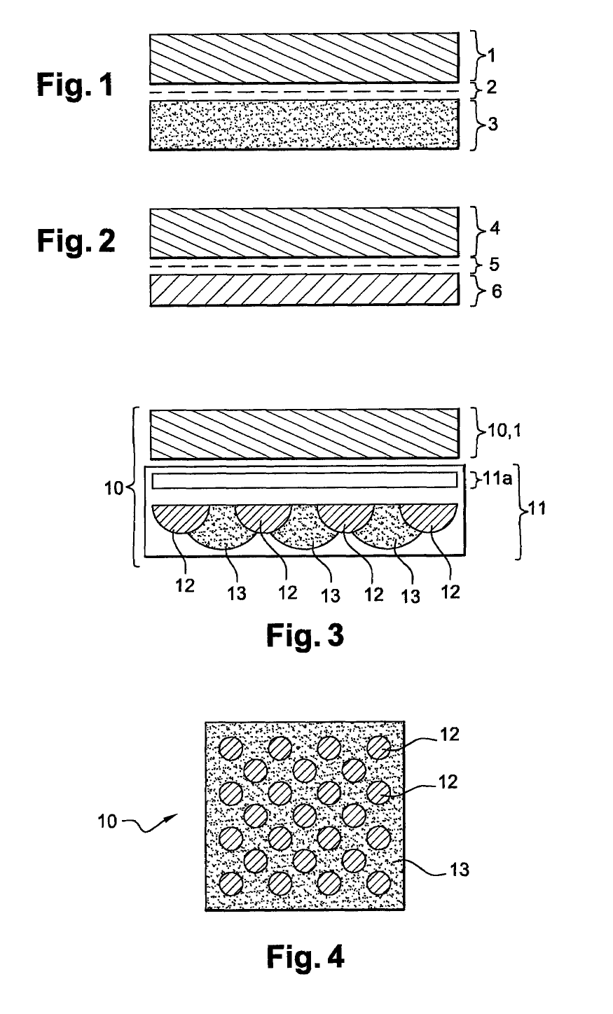

The current products proposed by the applicant are thus brought together in two different families each of which meets different degrees of need; and shown in FIGS. 1 and 2.

### a) Foam-Backed Material or Comfort Product (NF EN 651)

The products have the following structure shown in FIG. 1 with a heterogeneous surface-treated wearing course, reinforced or not reinforced with glass mesh (1), a reinforced covering substrate (2) and high density foam (3). These products, as shown in FIG. 1, provide the statutory acoustic comfort, but their crush performance which has a partial effect on rolling resistance makes them less attractive for hospital corridors.

### b) Compact Products (NF EN6 149) as Shown in FIG. 2.

These products include a surface-treated wearing course (4), an interlayer reinforcement in the form of a glass mesh (5) and with an underside of polyvinyl chloride. These products provide no acoustic comfort but demonstrate excellent crush behavior.

The procedure adopted by the applicant has been, in considering all these elements, to develop a new flooring concept including a sub-layer for a resilient floor with high dent resistance and other soundproofing performance, and which thereby combines all the aforementioned prior art advantages.

In a novel way, the solution proposed by the Applicant has been to dissociate the crush resistance side and the acoustic comfort providing side in order to act independently in respect of the two parameters.

Thus, according to the invention and according to a first characteristic, the flooring is of the type that comprises a heterogeneous, reinforced or not reinforced, wearing course, which is characterized in that the sub-layer comprises a flexible covering substrate on which are arranged a plurality of rigid or flexible projections, said projections being associated with a low density foam and in that the foam surrounding said projections overlaps them while leaving the upper part of said projections exposed.

These characteristics and some others will become clearer in the remainder of the description.

To fix the object of the invention shown non-restrictively in the drawings where:

FIGS. 1 and 2 are diagrammatic cross-section views of the current floor coverings proposed by the Applicant as they relate to floor coverings placed on foam and on a compact underside.

FIG. 3 is a diagrammatic cross-section view of the inventive flooring.

FIG. 4 is a view from beneath in accordance with FIG. 3.

To give more concrete expression to the object of the invention, the latter is now described non-restrictively as shown in the drawings.

The inventive flooring is given the overall reference number (10) and comprises a heterogeneous, reinforced or not reinforced, wearing course (10.1), which is remarkable in that it receives a sub-layer (11) which includes a flexible covering substrate (11a) on which are placed rigid or flexible projections (12) between which is integrated a low density foam (13). These projections are arranged evenly or unevenly. They are configured as semi-spheres and the low density foam (13) partially covers them leaving the upper end part exposed. The sub-layer as implemented thus meets the objectives sought. The projections offer better compression and dent resistance while the foam deadens the sound. These projections are made of a plastic material and particularly of plasticized polyvinyl chloride whereof the hardness has been adjusted. These projections are directly integrated on a continuous basis when the flooring is manufactured. They are approximately between 0.6 and 1.2 mm and preferably 0.9 mm high.

By virtue of their composition the projections provide support for the flooring structure when under crush stress. Their mechanical behavior gives excellent performance in the dent test, and the mechanical properties also guarantee continuity of performance.

The association of low density foam, given the raised contours obtained, and the appropriate acoustic qualities it provides gives very good acoustic insulation. In terms of rolling resistance, the resulting composite structure makes it possible after a value test to get close to the characteristics obtained with the compact materials shown in FIG. 2.

The solution proposed by the applicant offers great advantages and meets the objectives sought, by optimizing high dent resistance and high soundproofing performance.

1. Resilient floor covering with high dent resistance and high soundproofing performance, comprising a heterogeneous, reinforced or not reinforced, wearing course having a sub-layer comprising a flexible covering substrate on which are arranged a plurality of rigid or flexible projections, said projections being associated with a low density foam, wherein foam surrounding said projections overlaps the projections, while leaving an upper part of said projections exposed.

2. Floor covering as claimed in claim 1 wherein the projections are made of plastic material.

3. Floor covering as claimed in a claim 1, wherein the projections are approximately between 0.6 mm and 1.2 mm high.

4. Method for manufacturing floor covering as claimed in claim 1, wherein the projections are integrated on a continuous basis when the floor covering is manufactured.

5. Floor covering as claimed in claim 2, wherein the projections are made of plasticized polyvinyl chloride.
